(19) United States
(12) Patent Application Publication
(10) Pub. No.: US 2005/0248121 A1
(43) Pub. Date: Nov. 10, 2005

(54) Automatic wheelchair brake device

(76) Inventor: Jerry Ford, St. Charles, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/118,957

(22) Filed: Apr. 29, 2005

Related U.S. Application Data
(60) Provisional application No. 60/602,125, filed on Aug. 17, 2004.
(60) Provisional application No. 60/567,907, filed on May 4, 2004.

(51) Int. Cl. B62H 1/00

(52) U.S. Cl. 280/304.1

(57) ABSTRACT

The present automatic wheelchair brake device invention includes a brake mechanism adapted to be installed on an existing collapsible wheelchair. The brake mechanism may be adapted to be operably installed on only one side of a frame of the collapsible wheelchair such that a side-to-side collapsibility of the frame of the collapsible wheelchair is significantly unimpeded by the brake mechanism. The brake mechanism may be movable between an engaged position that generally inhibits rolling movement of the wheelchair and a disengaged position permitting free rolling movement of the wheelchair in response to movement of structure on the one side of the frame of the collapsible wheel chair between a first position when the wheelchair is occupied and a second position when the wheelchair is unoccupied.

### PRIORITY

This application claims the benefit of provisional patent application Ser. No. 60/602,125 filed on Aug. 17, 2004, and provisional patent application Ser. No. 60/567,907 filed on May 4, 2004, both of which are incorporated herein by reference in their entirety.

### FIELD OF THE INVENTION

The invention generally relates to braking devices for wheelchairs. More particularly, the invention relates to an automatic wheelchair brake device weight-actuated brake mechanism for wheelchairs that is automatically actuated depending upon the position of the user with respect to the wheelchair.

### BACKGROUND OF THE INVENTION

A conventional manual wheelchair is illustrated in FIGS. 1 and 2. Conventional manual wheelchairs 50 typically comprise a foldable frame 52, a seat 54 and a backrest 56, and a pair of manual brake mechanisms 58a and 58b. Two large drive wheels 60a and 60b are typically rotatably mounted to the foldable frame 52 to permit a user to operate and move the wheelchair. The manually operated hand brakes 58a and 58b are coupled to the wheelchair to engage and prevent rotational movement of the drive wheels. Conventional wheelchairs 50 also typically include leg rests 62 and armrests 64 for the comfort of the user.

The manual brake mechanisms 58a and 58b allow either a user or an attendant to lock the wheels of the wheelchair when exiting, for example, so that the chair does not move away when a patient attempts to enter or exit. Although the conventional manual brake mechanisms are sufficient for their intended purpose once engaged, the requirement that the user must remember to actuate the brakes leaves these devices susceptible to user error. For example, a conventional wheelchair will remain freely moveable if a user or attendant forgets to manually pivot the braking device and lock the wheels. The wheelchair may also remain freely moveable if a user or attendant does not fully apply the manual braking device to the wheels. As a result, a user attempting to stabilize himself or herself while entering or leaving the wheelchair, is at an increased risk of falling and injury due to the freely moveable wheelchair moving out from beneath them.

Attempts have been made to devise wheelchair-braking devices that automatically engage a wheel of a wheelchair when a user attempts to enter or leave the seat. For example, U.S. Pat. No. 5,894,912 to Dobben includes a sensing lever that senses when a user is entering or leaving the seat of a wheelchair. When the sensing lever senses a user exiting the seat it causes a braking lever to engage the wheels, thereby preventing free movement of the wheelchair. While the design of the wheelchair-braking device in Dobben fulfills its intended purpose, it has at least one significant shortcoming. In particular, the sensing lever, disposed beneath the seat, is continuously biased against a seated user. The continuously biased state of the sensing lever creates uncomfortable pressure points that are continuously felt by the seated user. These pressure points may additionally promote development of sores by the patient.

Another attempt at devising an automatic braking-device for a wheelchair is illustrated in U.S. Pat. No. 6,371,503 to Ritchie, et al. Ritchie discloses an L-shaped actuator that confronts a rear portion of the seat of a wheelchair. When a user sits in the wheelchair the seat engages the L-shaped actuator, which releases the braking-device. The actuator continues to press against the seated user until they exit the wheelchair. The automatic braking-device of Ritchie is susceptible to the same shortcomings as Dobben discussed above. In particular, the constant pressure by the actuator on the seated user creates a pressure point.

Other attempts to invent automatic braking-devices for wheelchairs have resulted in undesirably complicated braking assemblies. For example, U.S. Pat. No. 4,620,818 to Knoche, discloses a wheelchair having a sliding side frame that engages a pair of brake arms pivotally coupled to the wheelchair. The brake arms engage the wheels of the wheelchair as a user sits in the seat. Not only is the automatic braking assembly disclosed in Knoche overly-complicated, it also requires a user to modify the wheelchair's existing brake system. In particular, each of the brake arms includes a transverse portion that replaces the conventional manual wheelchair device. As a result, the modified wheelchair has only one braking device. Additionally, modifying the wheelchair in order to attach the transverse portion of the braking assembly may result in voiding the warranty of the wheelchair.

Still other attempts to resolve the problem associated with conventional wheelchair braking systems have resulted in modified wheelchair frames. For example, U.S. Pat. No. 5,984,334 to Dugas discloses a wheelchair with a moveable seat operationally coupled to a braking mechanism that locks one or more wheels when a user attempts to exit the seat. Another example of a modified device is U.S. Pat. No. 5,451,193 to Pickard. Pickard discloses a new wheelchair having four wheels of the same size. Additionally, the Pickard wheelchair is convertible to a walker. The custom nature of the Dugas and Pickard wheelchairs results in higher manufacturing costs, which are typically passed on to the consumer resulting in a more expensive wheelchair.

Another disadvantage with the previous attempts to provide automatic brake devices to a wheelchair is that the brake devices disable the manual wheelchair's ability to fold for storage or transport.

There remains a need in the wheelchair industry to provide an automatic braking mechanism that intervenes and prevents injuries caused by a freely movable wheelchair rolling out beneath a user as they attempt to enter or leave the seat portion, while addressing manufacturing, operability, cost and functional design issues.

### SUMMARY OF THE INVENTION

The present invention, through various embodiments, provides an automatic wheelchair brake device that addresses the deficiencies of the prior art attempts to provide a wheelchair with automatically applying brakes. In particular embodiments as will be described herein, the automatic wheelchair brake device is generally easily retrofittable to an existing wheelchair frame. The ease of retrofitability is enhanced by configuring the brake device to use existing fastening points on the wheelchairs' frame. The mechanism to sense when a patient sits in the chair, thereby causing the brakes to release, is designed to not present pressure points to the patient. In addition, the wheelchair's normal folding operation is preserved. Brake mechanism operate independently of each other when applied to each side of a wheelchair. The brake device of the present invention may also be manufactured for a minimum of cost compared to automatic brake designs in the prior art.

The present automatic wheelchair brake device invention according to particular embodiments includes a brake mechanism adapted to be installed on an existing collapsible wheelchair. The brake mechanism may be adapted to be operably installed on only one side of a frame of the collapsible wheelchair such that a side-to-side collapsibility of the frame of the collapsible wheelchair is significantly unimpeded by the brake mechanism. The brake mechanism may be movable between an engaged position that generally inhibits rolling movement of the wheelchair and a disengaged position permitting free rolling movement of the wheelchair in response to movement of structure on the one side of the frame of the collapsible wheel chair between a first position when the wheelchair is occupied and a second position when the wheelchair is unoccupied.

The automatic wheelchair brake device according to another embodiment includes a brake mechanism movable between an engaged position that generally inhibits movement of a wheel of a wheelchair when unoccupied and a disengaged position permitting free movement of the existing wheelchair when occupied. The brake device may further comprise a seat engagement assembly operable coupled to the brake mechanism, the seat engagement assembly configured to be generally free from creation of pressure points on an occupant of the wheelchair.

Another embodiment of the present invention includes a method of automatically applying brakes on a wheelchair without imparing the foldability of the wheelchair or presenting pressure points on an occupant of the wheelchair. This method may include providing a brake mechanism to a frame of a wheelchair, biasing the brake mechanism in an unoccupied position when the wheelchair is unoccupied wherein a wheel of the wheelchair is generally restrained from rotating when the chair is unoccupied, and contacting a frame of the wheelchair proximate a seat of the wheelchair when a patient sits in the wheelchair, thereby moving the brake mechanism to an occupied position, wherein the wheel generally unrestrained from rotating.

The above summary of the present invention is not intended to describe each illustrated embodiment or every implementation of the present invention. The following figures and detailed description more particularly exemplify the embodiments of the present invention.

### BRIEF DESCRIPTION OF THE DRAWINGS

The invention may be more completely understood in consideration of the following detailed description of various embodiments of the invention in connection with accompanying figures, in which:

FIG. 1 is a perspective view of a conventional manual wheelchair with manually operated brake mechanism.

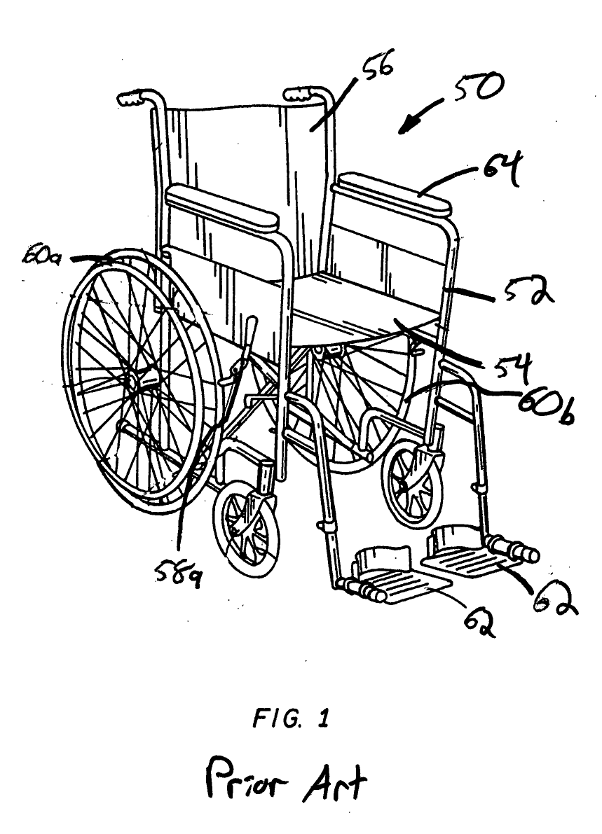

FIG. 2 is a front view of a conventional manual wheelchair with manually operated brake mechanism.

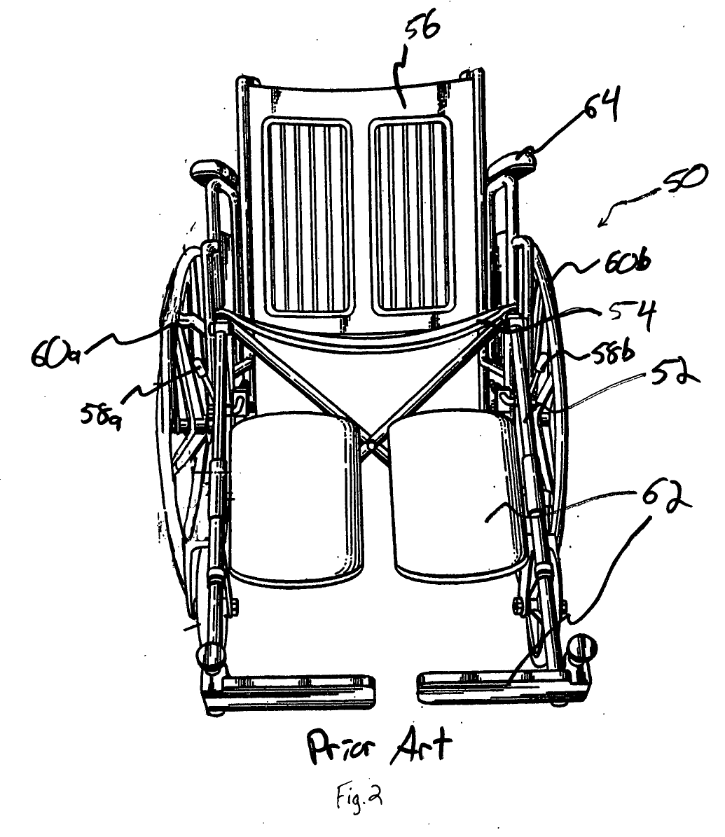

FIG. 3 is a rear view of a wheelchair brake mechanism according to an example embodiment of the present invention

FIG. 4 is a partial exploded rear view of a wheelchair brake mechanism according to an example embodiment of the present invention.

FIG. 5A is a side view of a wheelchair brake mechanism in an engaged position according to an example embodiment of the present invention.

FIG. 5B is a side view of a wheelchair brake mechanism in a disengaged position according to an example embodiment of the present invention.

FIG. 5C is a side view of a wheelchair brake mechanism in an engaged position and showing how portions of said mechanism move to a disengaged position according to an example embodiment of the present invention.

FIG. 6A is rear partial cross section view of a wheelchair brake mechanism in an engaged position according to an example embodiment of the present invention.

FIG. 6B is rear partial cross section view of a wheelchair brake mechanism in an engaged position and showing how portions of said mechanism move to a disengaged position according to an example embodiment of the present invention.

FIG. 6C is a side view of a wheelchair brake mechanism in an engaged position showing how portions of said mechanism move to a disengaged position according to an example embodiment of the present invention.

FIG. 7 is an enlarged view of FIG. 6A according to an example embodiment of the present invention.

FIG. 8A is a side view of another embodiment of a wheelchair brake mechanism in a disengaged position according to an example embodiment of the present invention.

FIG. 8B is a side view of another embodiment of a wheelchair brake mechanism in an engaged position according to an example embodiment of the present invention.

FIG. 9 is a side view of an attendant controlled brake release assembly of a wheelchair brake mechanism according to an example embodiment of the present invention.

FIG. 10A is an end view of an attendant brake release assembly of a wheelchair brake mechanism according to an example embodiment of the present invention.

FIG. 10B is a cross section view of an attendant brake release assembly of a wheelchair brake mechanism according to an example embodiment of the present invention.

FIG. 10C is a side view of an attendant brake release assembly of a wheelchair brake mechanism according to an example embodiment of the present invention.

FIG. 11 is a side view of a wheelchair brake mechanism according to an example embodiment of the present invention.

FIG. 12 is a side view of a wheelchair brake mechanism according to an example embodiment of the present invention.

FIG. 13 is a rear view of a wheelchair brake mechanism according to an example embodiment of the present invention.

FIG. 14 is a top view of a wheelchair brake mechanism according to an example embodiment of the present invention.

FIG. 15 is an enlarged view of a portion of FIG. 13.

FIG. 16 is a side view of an attendant break release assembly and a friction brake assembly according to an example embodiment of the present invention.

FIG. 17 is a side view of an attendant break release assembly and a friction brake assembly according to an example embodiment of the present invention.

FIG. 18 is an end view of an attendant break release assembly and a friction brake assembly according to an example embodiment of the present invention.

While the present invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF PREFERRED EMBODIMENTS

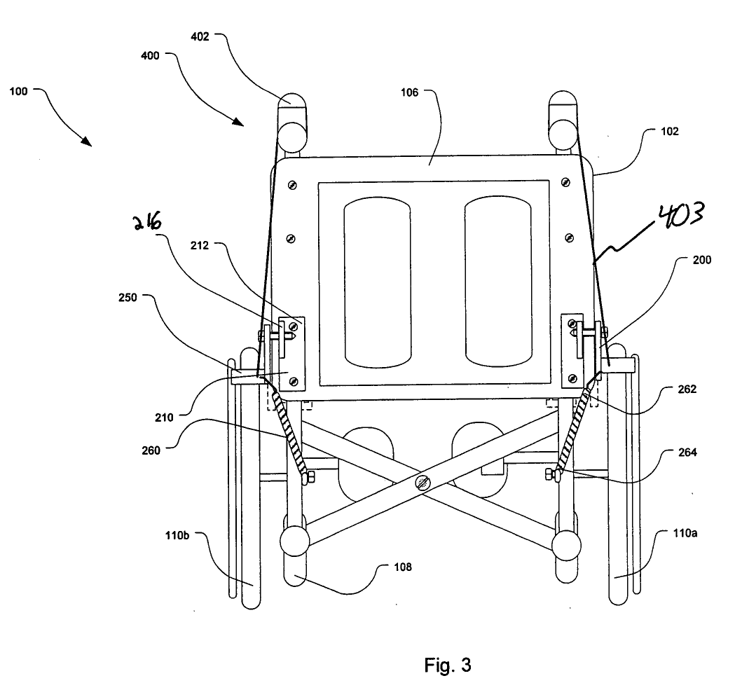

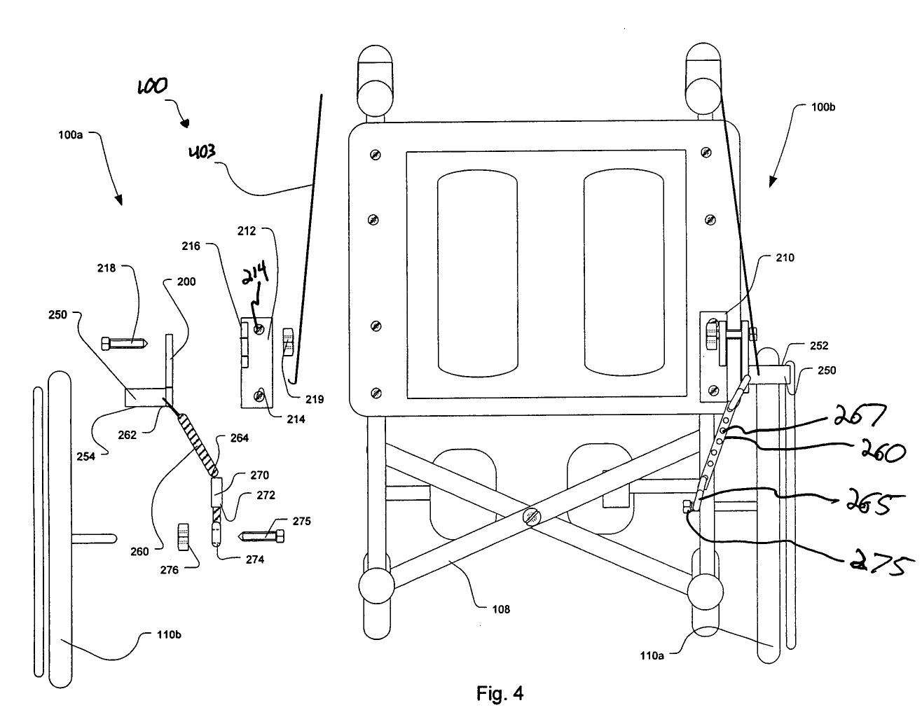

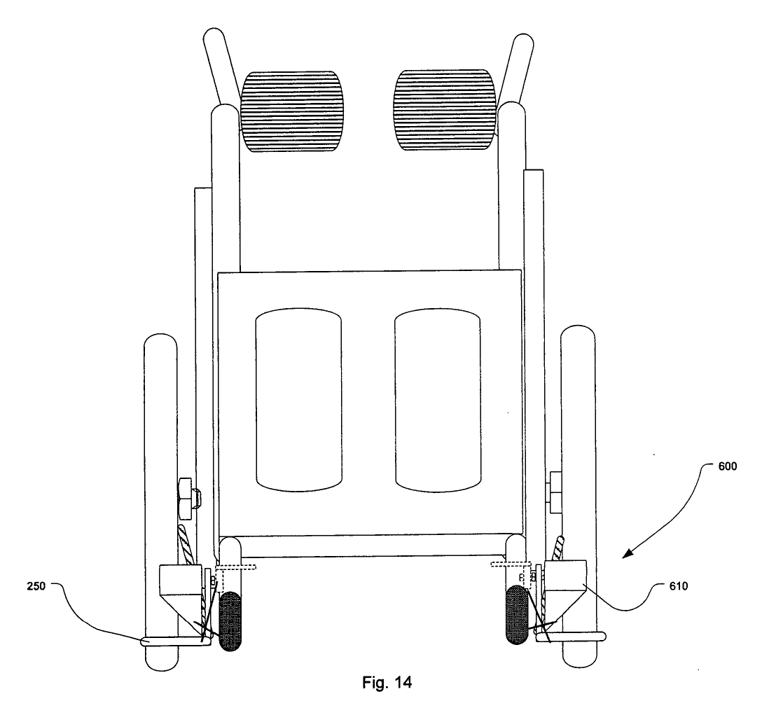

FIGS. 3-18 collectively illustrate a wheelchair with a weight-actuated brake mechanism, indicated by numeral 100, to control the free movement of the wheelchair. Referring generally to FIGS. 3-5C, and particularly to FIGS. 3 and 4, typically two wheelchair brake mechanisms 100a (in an exploded view) and 100b are attached to a wheelchair 102. Each wheelchair brake mechanism 100a and 100b controls the rotational movement of each of drive wheels 110a and 110b respectively. The following description of the wheelchair brake mechanisms 100a and 100b will be discussed singularly, but it should be noted that it applies equally to both mechanisms 100a and 100b.

The wheelchair brake mechanism 100a includes at least one support structure 200 comprising an elongate bar that is pivotally coupled to a portion of the foldable frame 108. Although an elongate bar is shown and discussed as one of the example embodiments, it should also be noted that the support structure 200 may also comprise a rod or other similar component. The support structure 200 is preferably disposed generally between a respective drive wheel 110a, 110b and the foldable frame 108. At least a portion of the support structure 200 is disposed generally proximate the drive wheel 110a, such that it may engage the drive wheel 110a and prevent rotational movement thereof as a user enters or leaves the seat 104.

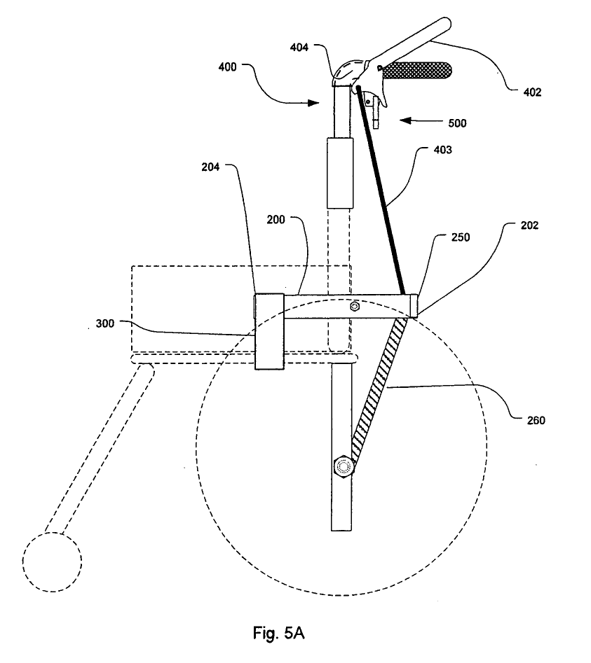

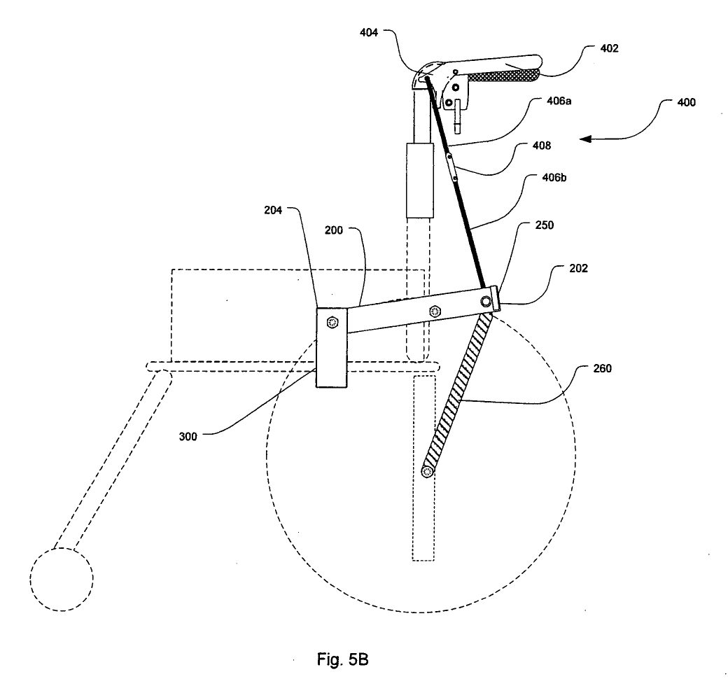

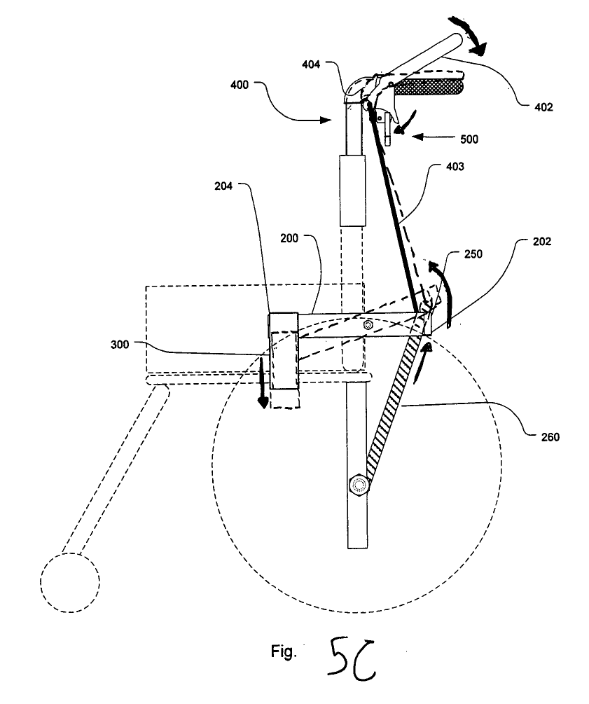

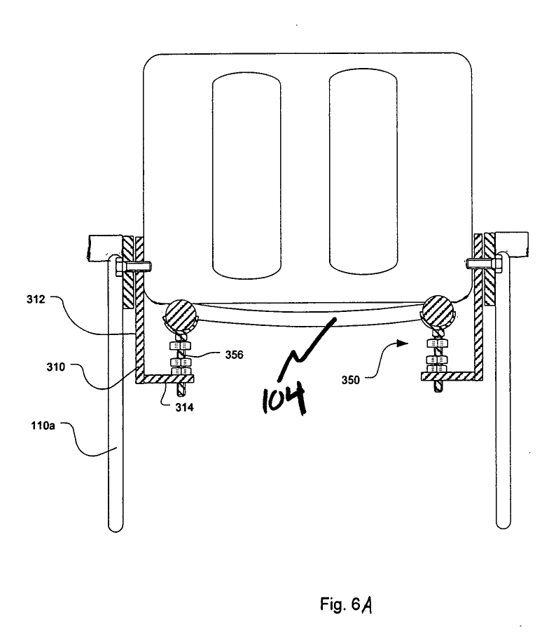

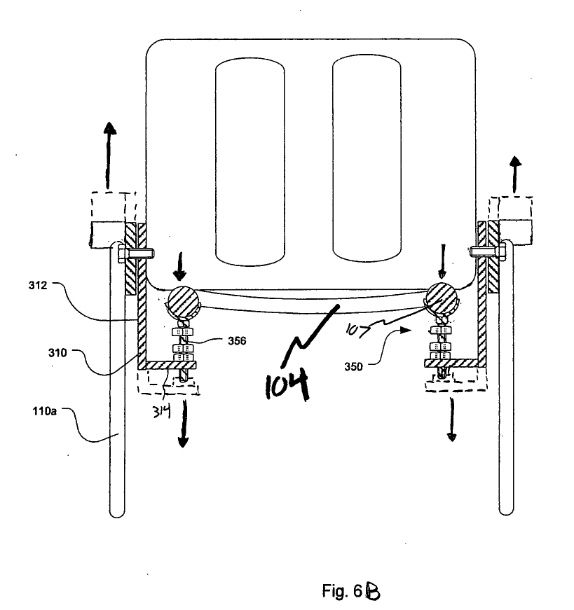

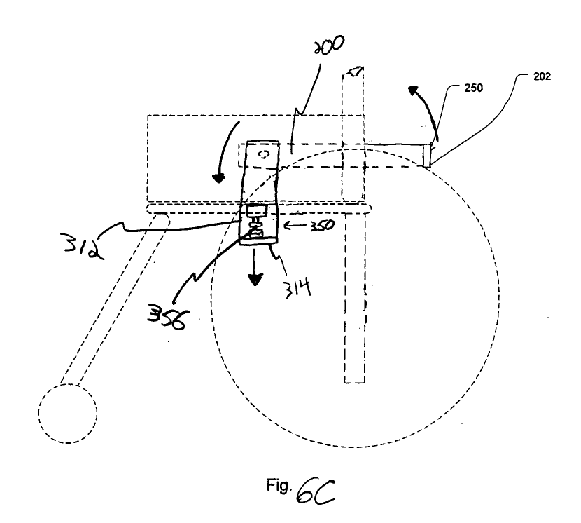

Referring to FIGS. 4, 5A, 5B and 5C, the support structure 200 includes first 202 and second 204 opposed ends. Referring to FIGS. 3 and 4, the support structure 200 is pivotally couplable to a support bracket 210 that is mountable to a portion of the foldable frame 108 of the wheelchair. In an example embodiment, the support bracket 210 is disposed on a rear portion of the foldable frame 108 defining the backrest of the wheelchair 106. The support bracket 210 is disposed generally proximate a juncture between the backrest 106 and the seat 104 (shown in FIG. 6A). The support bracket 210 includes a plate portion 212 that is mountable to the foldable frame 108 with at least one fastener 214, such as a screw, bolt, or like device. Fastener 214 preferably replaces existing fasteners fastened to the wheelchair 102. By using the pre-existing mounting holes or fastening points on an existing wheelchair, the present invention is easily and quickly retro-fittable to variety of wheelchairs without the need to make modifications such as drilling holes.

In one example embodiment, plate portion 212 may have a generally arcuate or curved shape to accommodate the foldable frame 108 of the wheelchair 102. The support bracket 210 also includes a flange portion 216 traversing away from an outer surface of the plate portion 212. A fastener 218 and coupler 219 pivotally couples the support structure 200 to the flange portion 216 of the support bracket 210. Any fastener may be used, such as a bolt and nut that would permit pivotal movement between the support structure 200 and the flange portion 216.

To facilitate locking and unlocking the drive wheels 110a and 110b of the wheelchair 102, the support structure 200 includes at least one braking lever 250 and at least one sensing lever assembly 300 extending away from the first 202 and second 204 ends respectively. Only one brake mechanism 100a or 100b is necessary to accomplish the desired braking function of the wheelchair 102. However, it is most common to pair a first 100a and a second 100b braking mechanism with the opposing wheels 110a and 110b. It should be noted that the operation of braking mechanism 100a is separate and not dependant on operation of braking mechanism 100b, and vise-versa. The independent operation is facilitated, in part, by each brake mechanism 100a and 100b having its own respective sensing lever assembly 300.

The braking assembly has a default engaged position, as illustrated in FIG. 5A, and disengaged position, as illustrated in FIG. 5B. FIG. 5C shows the engaged position with the disengaged position superimposed along with directional arrows indicating the direction of movement of the indicated components. In the engaged position, braking lever 250 is disposed adjacent to and confronts a portion of the drive wheel 110a preventing it from rotating freely. In the disengaged position, the braking lever 250 is disposed sufficient distance away from the drive wheel 110a to allow it to freely rotate. Sensing lever assembly 300 facilitates rotational movement or pivoting of the support structure 200 from the engaged position toward the disengaged position when a user is entering or leaving the wheelchair 102.

Referring back to FIGS. 3 and 4, braking lever 250 traverses away from the support structure 200 and extends generally toward the drive wheel 110a. In one example embodiment, the braking lever 250 extends away from the support structure 200 at generally a ninety-degree angle, such that the support structure 200 has a generally L-shape. Other angles and shapes such as C-shaped, J-shaped, S-shaped and other similar shapes are also envisioned to be within the spirit and scope of the invention. In one example embodiment of the invention, the braking lever 250 is integral to the support structure 200. In other embodiments of the invention the braking lever 250 may be detachably coupled to the support structure 200 to permit modification according to the wheelchair 102 being outfitted with the brake mechanism 100a.

Braking lever 250 comprises a generally rectangular plate or bar having a length generally greater than a width of the drive wheel 110a. The braking lever 250 also has an upper peripheral edge portion 252 and a lower peripheral edge portion 254. The lower peripheral edge portion 254 engages or confronts the drive wheel 110a when the support structure 200 is in the engaged position. In an example embodiment, the lower peripheral edge portion 254 is generally linear however; it may also have a generally curvilinear or arcuate shape such that it mimics the arcuate shape of the drive wheel 110a. The generally arcuate shape provides more surface contact between the braking lever 250 and the drive wheel 110a, thereby increasing rotational resistance.

Continuing with FIGS. 3-5C, the brake mechanisms 100a and 100b include a biasing or tension member 260 such as a coiled spring or adjustable elastomeric strap that is coupled to and extends generally between either the support structure 200 and a portion of the foldable frame 108 or between the braking lever 250 and a portion of the foldable frame 108. The biasing member 260 maintains support structure 200 in the default engaged position, as illustrated in FIG. 5A, when a user is not seated in the seat 104 of the wheelchair 102. By having the engaged position as the default position, the drive wheels 110a and 110b remain locked when the user is not seated, thereby immobilizing the wheelchair 102 and providing a stable structure for the user. Since the wheelchair 102 is immobilized, a user entering or leaving the seat 104 of the wheelchair 102 will have a significantly reduced chance of falling due to the wheelchair 102 coming out from under them.

Referring back to FIGS. 3 and 4, the biasing member 260 includes a first end 262 and a second end 264. The first end 262 is detachably coupled to either the braking lever 250 or the support structure 200. In one example embodiment, the second end 264 is detachably coupled to a portion of the foldable frame 108 such as illustrated in FIG. 3. In this example embodiment, the second end 264 of the biasing member 260 includes a hook or S-shape hook member 265 attached thereto to facilitate detachable coupling of the biasing member 260 to a portion of the foldable frame 108. The second end 264 of the biasing member 260 may be detachably coupled to a portion of the axle assembly 275 of the drive wheel 110a extending through a portion of the foldable frame 108 and secured thereto by a coupler 276 such as a nut or similar component. However, the second end 264 of the biasing member 260 may be attached anyplace on the wheelchair 102 that facilitates its ability to maintain the support structure 200 in the engaged position.

In other example embodiments of the invention, the second end 264 of the biasing member 260 is coupled to an adjustable coupler 270 that is coupled to a portion of the foldable frame 108 to permit a user to adjust its length and thereby the tension that the biasing member 260 exerts upon the support structure 200. In one example embodiment of the invention, as illustrated in FIG. 4, the adjustable coupler 270 may include a turnbuckle portion 272 and a threaded eyelet or hook portion 274. Rotation of the threaded eyelet portion 274 in a clockwise direction shortens the length of the adjustable coupler 270, thereby requiring the biasing member 260 to be stretched in order for the threaded eyelet portion 274 to be coupled to the foldable frame 108.

In another example embodiment, the biasing member 260 comprises an elongate generally elastomeric strap 260 having a plurality of spaced apertures or holes extending along a length thereof. In this example embodiment, adjustment is accomplished by changing the engagement point of the S-shaped hook 265 (or similar engagement device) to different apertures provided in the elastomeric strap. Other types of adjustable couplers 270 are also contemplated and considered to be within the spirit and scope of the present invention.

As the user is seated, the support structure 200 moves from the engaged position to the disengaged position. Returning to FIGS. 5A though 5C, the sensing lever assembly 300 is operably coupled to the support structure 200 and positionable beneath the seat 104 to sense when a user is entering or leaving the wheelchair 102. In one example embodiment, as a user enters the wheelchair 102 the seat 104 travels in a downward vertical direction until it confronts and vertically displaces the sensing lever assembly 300. The downward movement of the sensing lever 300 assembly causes the support structure 200 to pivot or rotate from the engaged position toward the disengaged position. In the engaged position, the drive wheel 110a is locked and not freely rotatable. With the user is seated, the support structure 200 in the disengaged position and the wheelchair 102 is freely moveable.

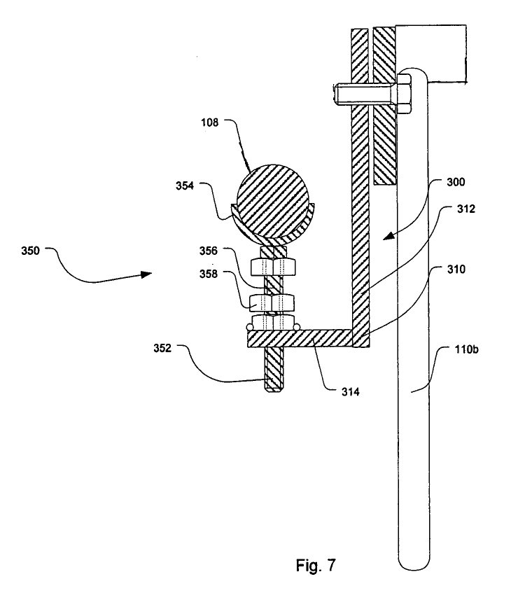

Various configurations are contemplated for actuating the sensing lever assembly 300. In one example embodiment, as illustrated in FIGS. 6A, 6B, 6C and 7, the sensing lever assembly 300 comprises a sensor bracket 310 having leg portion 312 pivotally coupled to the support structure 200 and a foot portion 314 transversely extending therefrom that is in operable communication with the seat 104 of the wheelchair 102. The leg portion 312 is generally vertically or perpendicularly oriented with respect to a longitudinal axis of the support structure 200. The foot portion 314 is oriented at a generally ninety degree angle with respect to the leg portion 312 such that the sensor bracket 310 has a generally L-shape. However, other shapes are also contemplated for the sensor bracket 310, including but not limited to C-shaped, U-shaped, and J-shaped. Regardless of the shape utilized, the sensor bracket 310 is oriented such that the foot portion 314 extends generally beneath a portion of the foldable frame 108 defining the seat 104 of the wheelchair 102.

Depending upon the weight of the user, it may be advantageous to be able to adjust the distance between the seat 104 of the wheelchair 102 and the foot portion 314. For example, a smaller user weighing less may need to decrease the distance to facilitate the seat 104 of the wheelchair 102 engaging the foot portion 314. A larger user weighing more may increase the distance to permit the user to become fully seated in the wheelchair 102 before the support structure 200 moves from the engaged position to the disengaged position.

In one example embodiment of the invention, as illustrated in FIGS. 6A, 6B, 6C and 7, a seat engagement assembly 350 is operably disposed on the foot portion 314 to facilitate adjustment of the distance between the seat 104 of the wheelchair 102 and the foot portion 314. As particularly illustrated in the example embodiment of FIG. 7, the seat engagement assembly 350 comprises a stop 352 having a saddle portion 354 and a shaft portion 356 adjustably disposed on the foot portion 314. The saddle portion 354 has a generally arcuate or curvilinear shape to accommodate a tubular shape of the foldable frame 108. The shaft portion 356 may be threadedly coupled to the foot portion 314, such that rotation of the shaft portion 356 adjusts the height of the stop 352 and thus the distance between the seat 104 of the wheelchair 102 and the foot portion 314. At least one threaded nut, bolt or similar component 358 may be disposed on the shaft portion 356 to secure the stop 352 at a particular height with respect to the foot portion 314. As particularly illustrated in FIG. 7, a plurality of threaded nuts is utilized to secure the stop 352 to the foot portion 314. Other embodiments of the seat engagement assembly 350 may also be utilized. For example, a cable having a pair of opposed ends coupled to the support structures 200 of the braking mechanisms 100a and 100b may be used. An adjustable pneumatic cylinder and piston rod may also be utilized.

FIG. 6A shows the sensing lever assembly 300 in the position where the wheel is engaged and no movement is possible. This position corresponds with an absence of a patient seated in the chair. When the patient sits on the seat, the rails 107 of the foldable frame 108 move downward as indicated by the arrows in FIGS. 6B and 6C. The downward movement of the rails causes the seat engagement assembly 350 to move the sensing lever assembly 300 downward as shown, which, in turn, causes the wheel to be released for free movement.

A wheelchair 102 with brake mechanisms 100a and 100b may be further enhanced by providing a means for bypassing the brake mechanism 100a and 100b when a user is not seated in the wheelchair 102. Such bypass means makes it easier for an attendant to transport an empty wheelchair that would otherwise have the brake mechanisms 100a and 100b engaged. In example embodiments, as illustrated in FIGS. 3, 5A, 5B, 5C, 8A-12, and 17-18, a brake release assembly 400 is coupled to the foldable frame 108 and operably coupled to the support structure 200. In one of the example embodiments, the brake release assembly 400 comprises at least one hand release lever 402 pivotally couplable to handles of the wheelchair 102. A linkage 403 is coupled to and extends between the hand release lever 402 and the support structure 200 or braking lever 250. The hand release lever 402 is pivotable between a depressed position or state and released position or state. As an attendant depresses the hand release lever 402 toward the depressed state it pivots the support structure 200 from the engaged position toward the disengaged position. As an attendant releases the hand release lever 402 from the depressed state toward the released stated, the support structure 200 pivots from the disengaged position toward the engaged position.

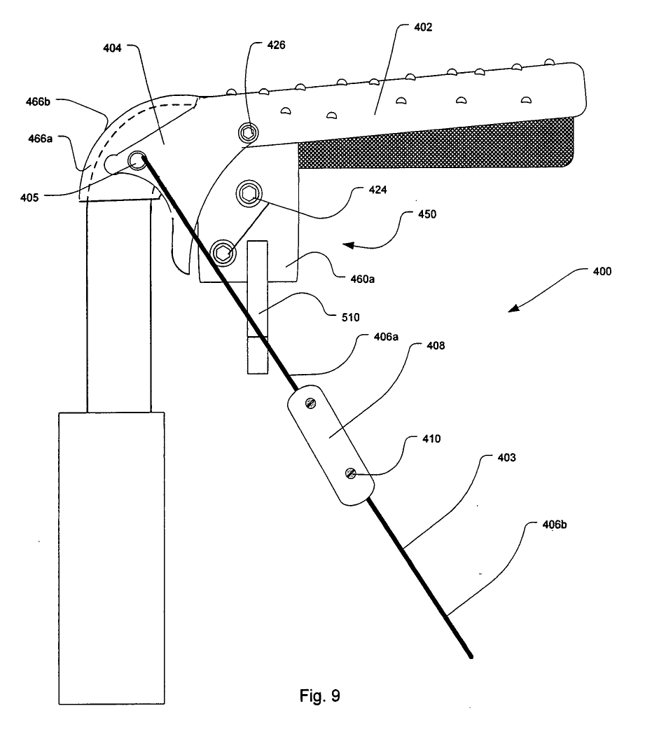

Referring now to FIGS. 5A-10B and particularly to FIG. 9, the hand release lever 402 includes at least one flange 404 having an aperture or hole 405 for attaching at least one end of the linkage 403. A second end of the linkage 403 is detachably coupled to the support structure 200 or braking lever 250. In one example embodiment, the hand release lever 402 is preferably disposed generally above the handle of the wheelchair 102 to allow gravity to assist an attendant in applying the hand release lever 402.

In one example embodiment of the invention, the hand release lever 402 may be manufacture from stainless steel. Additionally, the hand release lever 402 may have a generally textured outer surface and/or a contoured surface to facilitate gripping and/or comfort for an attendant grasping the hand release lever 402. Other configurations, materials and texturing are also contemplated by the present invention. Other materials may include aluminum, composite, polymer, or similar materials.

The linkage 403 comprises a generally rigid rod or wire according to one embodiment. Linkage 403 may be manufactured from various other materials such as steel, aluminum, titanium, composite polymer, or fabric. Any device that would link the hand release lever 402 and the support structure 200 may be used and is contemplated by the present invention.

A length adjustor 408 may be desirably disposed between a pair of linkage portions 406a and 406b to adjust an overall length of the linkage 403. The length adjustor 408 is used because the distance between the handles of the wheelchair 102 and the placement of the support structure 200 may vary depending upon the manufacturer of the wheelchair 102. The length adjustor 408 may comprise an elongate tube or cylinder having opposed open ends extending into an interior space thereof. Free ends of the linkage portions 406a and 406b may extend into the open ends of the length adjustor 408. Fasteners 410, such as screws, bolts or similar components may extend into the length adjustor 408 to engage and secure the linkage portions 406a and 406b in the interior of the length adjustor 408. Other devices such as turnbuckles may also be used to adjust the overall length of the linkage 403.

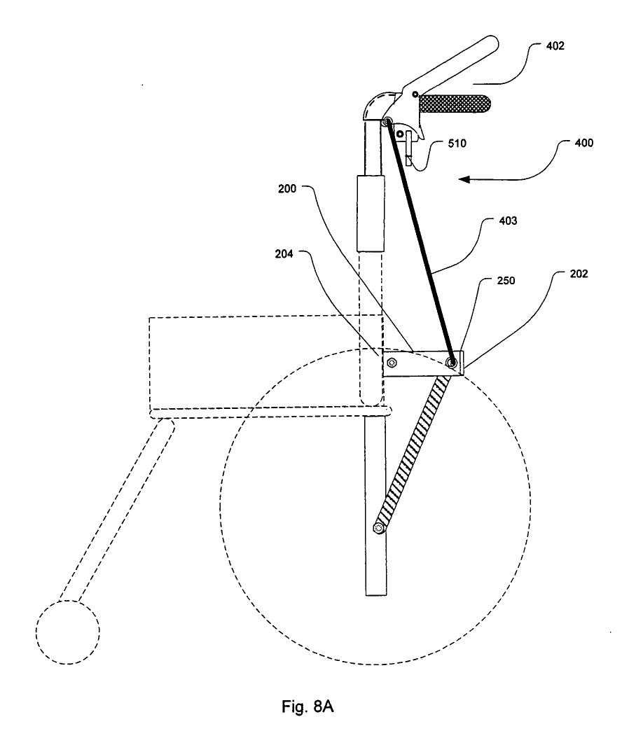

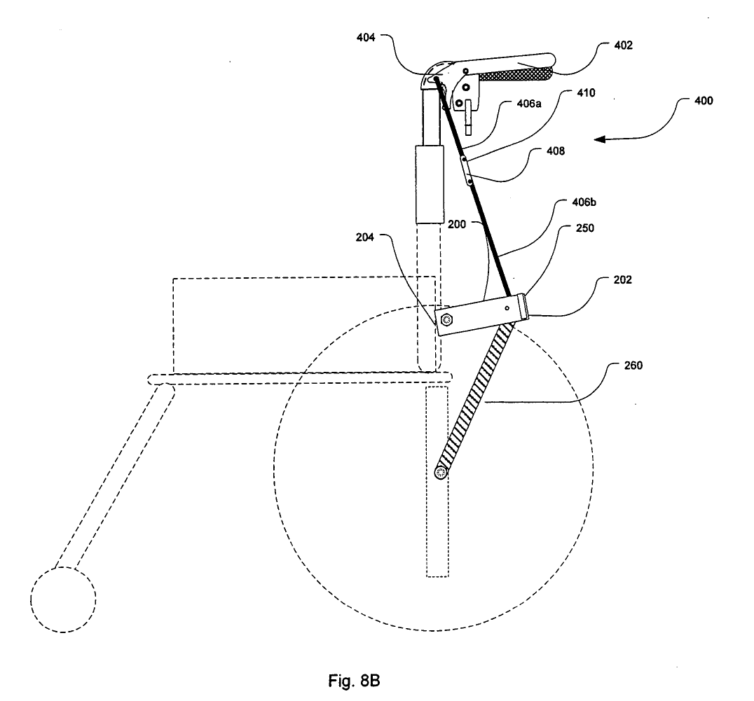

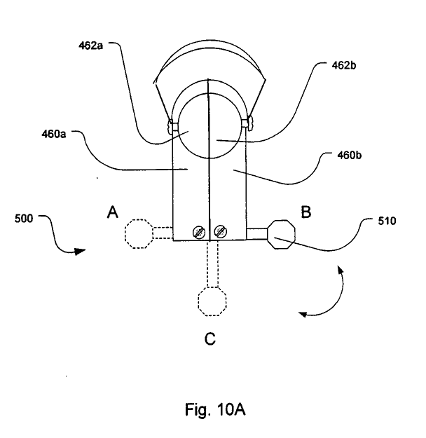

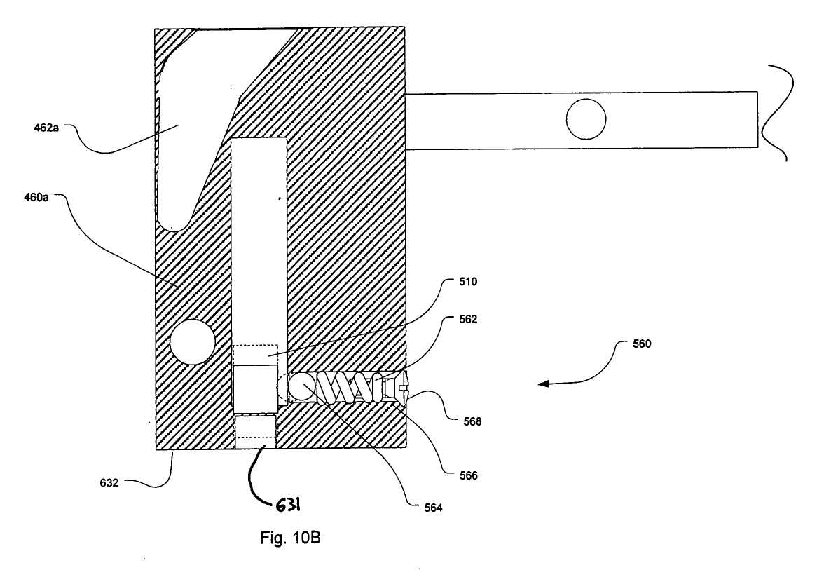

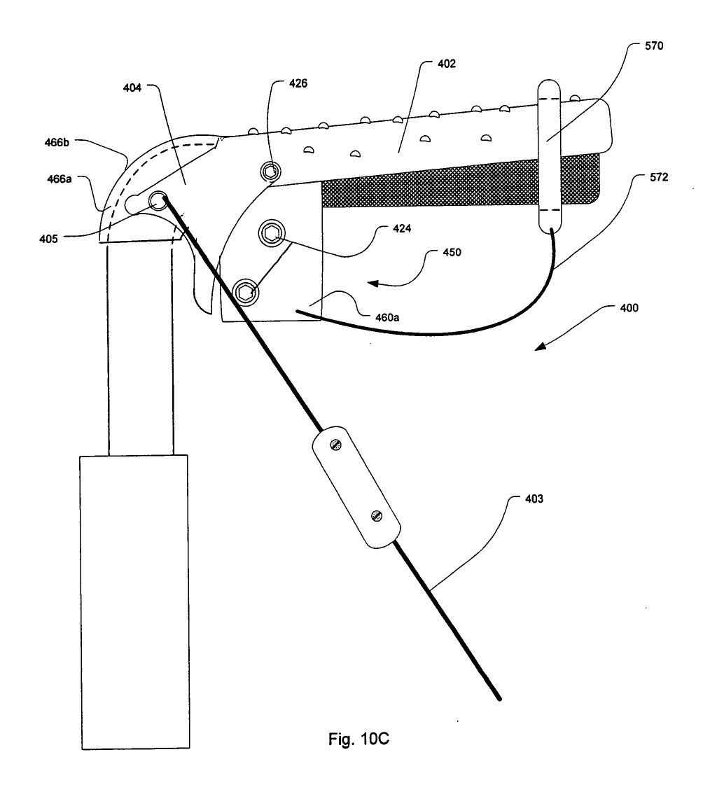

In another example embodiment, a brake release coupling assembly 450 is provided to facilitate coupling the brake release assembly 400 to the wheelchair 102 without having to modify the wheelchair 102. In this example embodiment, as illustrated in FIGS. 8A-10C and particularly FIG. 10A, the brake release coupling assembly 450 comprises a pair of coupling members 460a and 460b detachably coupled together about the handle of the wheelchair 102. Referring to FIGS. 10A and 10B, each of the coupling members 460a and 460b includes a groove, recess or channel 462a and 462b extending into an inner surface thereof for receiving the foldable frame 108 defining the handles of the wheelchair 102. As illustrated in FIG. 10A, when the coupling members 460a and 460b are coupled together grooves 462a and 462b define an aperture extending through at least a portion of the coupling members 460a and 460b. As particularly illustrated in FIG. 10B, each of the grooves 462a and 462b has a generally arcuate shape to accommodate the arcuate shape of the foldable frame 108. The grooves 462a and 462b may have various shapes, such as a generally linear or an approximately right angle depending upon the shape of the foldable frame 108.

In another example embodiment, as illustrated in FIG. 9, each of the coupling members 460a and 460b may include a shoulder portion 466a and 466b respectively extending generally curvilinearly away therefrom. The grooves 462a and 462b of the coupling members 460a and 460b may extend along an inner surface of the shoulder portions 466a and 466b to accommodate a generally arcuate shape of the foldable frame 108. The coupling members 460a and 460b may be machined from steel, aluminum, polymers, composites and similar materials. Additionally, the hand release lever 402 and the coupling members 460a and 460b may have a silver ion coating, which has been shown to kill bacteria, viruses and other pathogens.

To assemble the brake release assembly 400 each coupling member 460a and 460b is positioned adjacent to respective side of the foldable frame 108, such that the handles of the wheelchair 102 extend through the aperture defined by the coupling members 460a and 460b. Referring again to FIG. 9, fasteners 424, such as screws, bolts and similar components, are utilized to couple the coupling members 460a and 460b together. The hand release lever 402 is pivotally coupled to the coupling members 460a and 460b with a fastener 426, such as a screw, bolt and similar components.

Referring generally to FIGS. 5A-5B and 8A-10B, and FIG. 10A in particular, brake release assembly 400 may include a break release locking mechanism 500 operably coupled thereto to permit an attendant to maintain the support structure 200 in the disengaged position. In one example embodiment, a switch 510 is movably disposed to the coupling members 460a and 460b to selectively confront and prevent pivoting of the hand release lever 402 from the depressed state toward the released state. As discussed above, the support structure 200 is in the disengaged position when the hand release lever 402 is in the depressed state. Referring particularly to FIG. 10B, an end of the switch is pivotally disposed in a notch 631 extending into a lower surface or bottom 632 of each of the coupling members 460a and 460b.

Referring back to FIG. 10A, the switch 510 is positionable between a first locked position at A, a second locked position at B, and a released position at C. While the switch 510 is in the released position C, the hand release lever 402 will move freely from the depressed state toward the released state. An attendant can temporarily hold the hand release lever 402 in the depressed state by moving the switch 510 to the first locked position A and letting the flange 404 confront the switch 510. The force exerted on the flange 404 by the biasing member 260 acting on the support structure 200 and the linkage 403 keeps the switch 510 in the first locked position A and prevents the hand release lever 402 from pivoting toward the released position.

There are at least two methods for moving the switch 510 from the first locked position to the released C position. The first method occurs when a user sits in the seat 104 of the wheelchair 102. As a user sits down, the support structure 200 pivots from the engaged position toward the disengaged position causing the linkage 403 to at least slightly displace the hand release lever 402. The displacement of the hand release lever 402 reduces the pressure on the switch 510, thereby permitting gravity to act on the switch 510 and move it to the released C position. Permitting movement of switch 510 from the locked position A to the released position C when a user sits in the seat 104 ensures brake mechanism 100a will move from the disengaged position toward the engaged position once the user attempts to rise up from the wheelchair 102.

The second method of moving the switch 510 from the first locked position A to the released position C occurs when an attendant depresses hand release lever 402. Once the force created by the biasing member 260 acting on the support structure 200 and linkage 403 is removed from the switch 510, gravity freely moves it toward the released position C.

An attendant can also keep the hand release lever 402 in the depressed stated by moving the switch 510 to the second locked position B and letting the hand release lever 402 confront switch 510. Once switch 510 is placed in the second locked position B, hand release lever 402 will not be able to move toward the released stated even if it is depressed again or a user sits in the seat 104 of the wheelchair 102. The switch 510 is maintained in the second locked position B, by a securing assembly 560 operably disposed in at least one of the coupling members 460a or 460b.

In one example embodiment, as illustrated in FIG. 10B, the securing assembly 560 comprises a coiled spring or other biasing member 562 disposed in a bore 566 extending through the coupling member 460a or 460b and into the notch 631. An engagement member 564, such as a ball bearing or similar device, is also disposed in the bore 566 and is biased against a portion of the switch 510 when it is in the second locked position B. The bore 566 may have a diameter slightly smaller than a diameter of the engagement member 564 or it may taper toward the notch 631, such that the engagement member 564 is prevented from completely escaping from the bore 566 when the switch 510 in not in the second locked position B. A fastener 568 may also be threadedly disposed in the bore 566 to facilitate removably retaining the securing assembly 560 in the bore 566. To permit the hand release lever 402 to move from the depressed state toward the released state, and simultaneously move the support structure from the disengaged position toward the engaged position, an attendant forces or pivots switch 510 toward release position C, whereby the biasing member 260 and linkage 403 force the hand release lever 402 to move from the depressed state toward the released state.

In another embodiment, as illustrated in FIG. 10C, a locking collar 570 may be tethered by a strap 572, chain or similar structure to the coupling portions 460a and/or 460b. The locking collar 570 is operably couplable about the hand release lever 402 and the handle of the wheelchair 102 when the hand release lever 402 is in the depressed state. The locking collar 570 may comprise an annular ring or plate having an aperture extending therethrough for receiving the hand release lever 402 and the handle of the wheelchair 102. In other embodiments, the locking collar 570 may comprise a plate or ring having a C-shape, U-shape or similar shapes.

In some instances it may not be advisable to have a wheelchair that can move freely when a user or patient is seated; for example, if the patient is suffering from Alzheimer's or other similar diseases that affects a patient's memory. In this instance, as illustrated in FIGS. 8A and 8B, the brake mechanisms 100a and 100b include only a support structure 200 and a braking lever 250 pivotally coupled to the foldable frame 108. There is no sensing lever assembly 300 to pivot the support structure 200 from the engaged position toward the disengaged position. As discussed above, the biasing member 260 extends between the support structure 200 or braking lever 250 and a portion of the foldable frame 108 to maintain the support structure 200 in the engaged position. When a user sits in the seat 104 of the wheelchair 102 it does not move the support structure 200 and braking lever 250 to the disengaged position.

The brake release assembly 400 may be utilized to facilitate transport of either the patient seated in the wheelchair 102 or an empty wheelchair 102. In this example embodiment, the relationship of a user or patient's position in the seat 104 of the wheelchair 102 does not affect the brake mechanisms 100a and/or 100b. In this particular example embodiment, securing assembly 560 may not be disposed in the bore 566 of one of the coupling members 460a or 460b. Instead, a pin or similar structure may be securely or removably disposed therein to prevent the hand release lever 402 from being secured in the depressed state. This arrangement ensures that the wheelchair 102 is always locked unless an attendant is present. An attendant can still temporarily lock hand release lever 402 in position A to transport the wheelchair 102. However, as discussed above, as soon as a user is seated in the wheelchair 102 the switch 510 automatically moves to the released position C to ensure that the wheelchair 102 will be secured if the user attempts to rise up from the wheelchair 102.

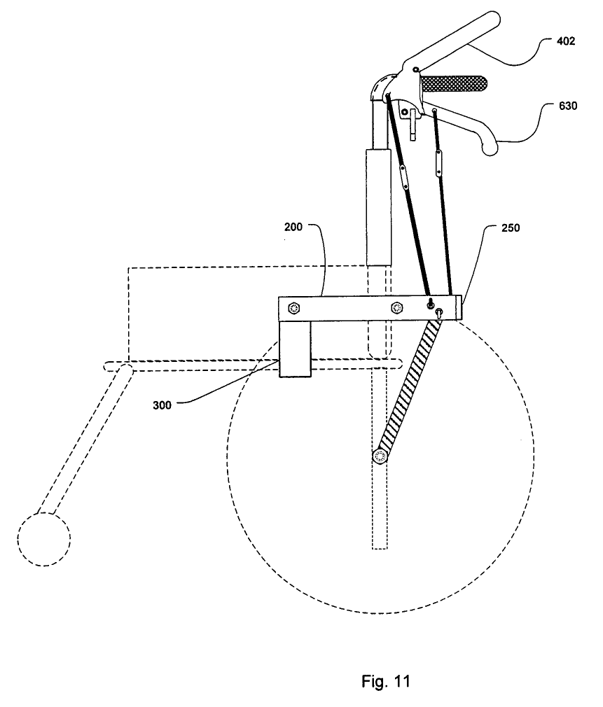

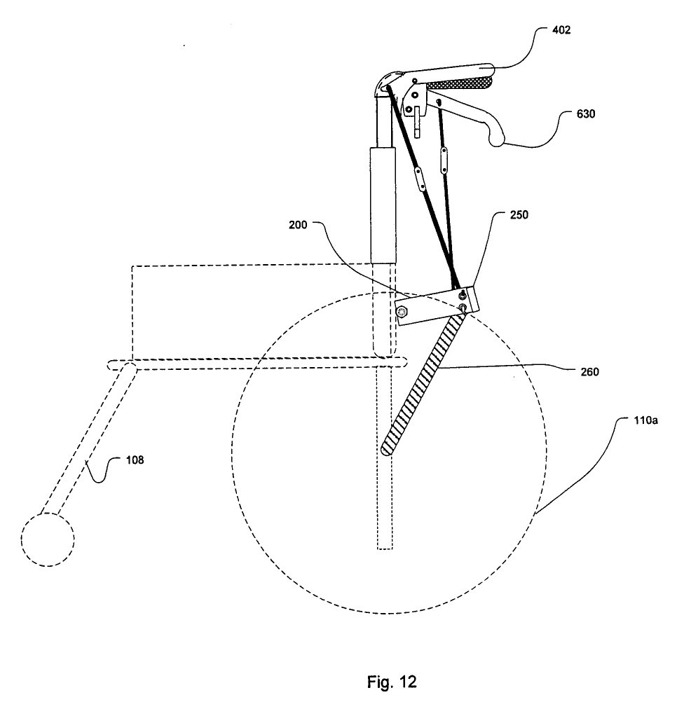

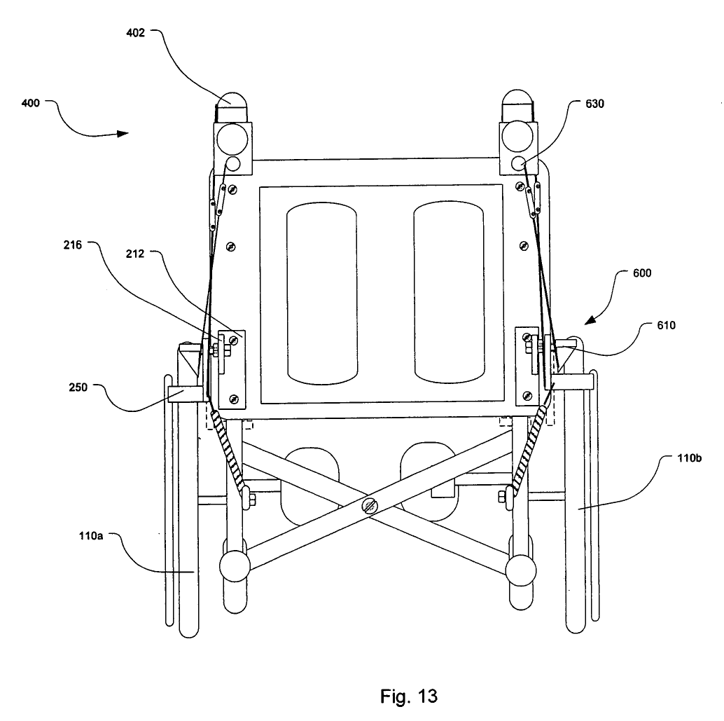

Occasionally, attendants transporting patients in wheelchairs 102 have to maneuver the wheelchairs 102 down an incline, such as a long sloping driveway, or a wheelchair access ramp of a building. Referring to FIGS. 11-18, a friction brake assembly 600 may be coupled to a wheelchair 102 in conjunction with the brake mechanisms 100a and 100b. Additionally, the friction brake assembly 600 may be used with (FIG. 11) or without (FIG. 12) the sensing lever assembly 300 pivotally coupled to the support structures 200. In one example embodiment, as illustrated in FIGS. 13-15, the friction brake assembly 600 includes a control lever 610 comprising a plate portion 612 disposed adjacent to a top of the drive wheel 110a and/or 110b and an anchor portion 614. The plate portion 612 is oriented in a generally horizontal plane such that a lower surface of the plate portion 612 confronts the drive wheel 110a and/or 110b to slow rotation thereof while the wheelchair 102 is moving either on a flat surface or down an incline. In one embodiment, the anchor portion 614 is disposed between the drive wheel 110a or 110b and the foldable frame 108 and is oriented at a generally right angle to the plate portion 612. However, it is contemplated that the anchor portion 614 may be oriented at any angle with respect to the plate portion 612.

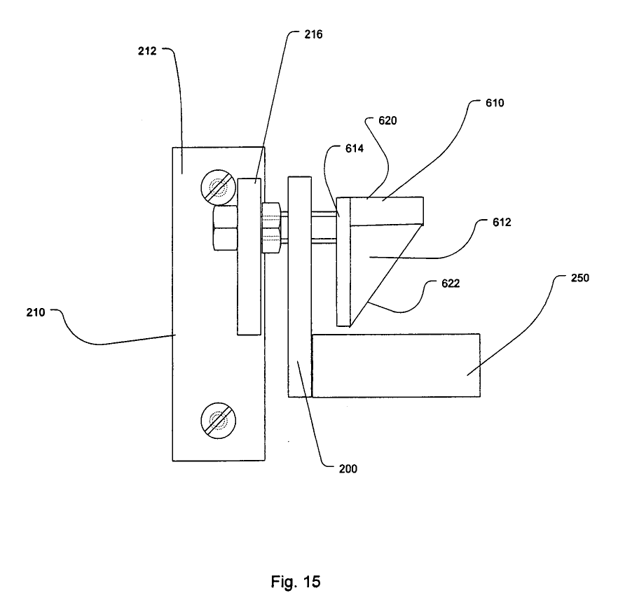

As particularly illustrated in FIG. 15, the anchor portion 614 may be pivotally coupled to the support bracket 210, such that the support structure 200 and the anchor portion 614 have generally the same pivot point. A spacer (not shown) comprising a cylinder, washer or a similar structure, may be disposed between the anchor portion 614 and the support structure 200 to prevent operational interference. The plate portion 612 may have a front edge 620 and rear edge 622 corresponding with a front and rear of the wheelchair 102. The rear edge 622 of the plate portion 612 may have a generally smaller width than the front edge 620 such that the plate portion 612 has a generally triangular shape. The plate portion 612 may have any shape such as generally curvilinear or arcuate to accommodate the curvature of the drive wheels 110a and 110b. Other shapes and configurations such as C-shaped, U-shaped, V-shaped are also contemplated and considered to be within the spirit and scope of the invention.

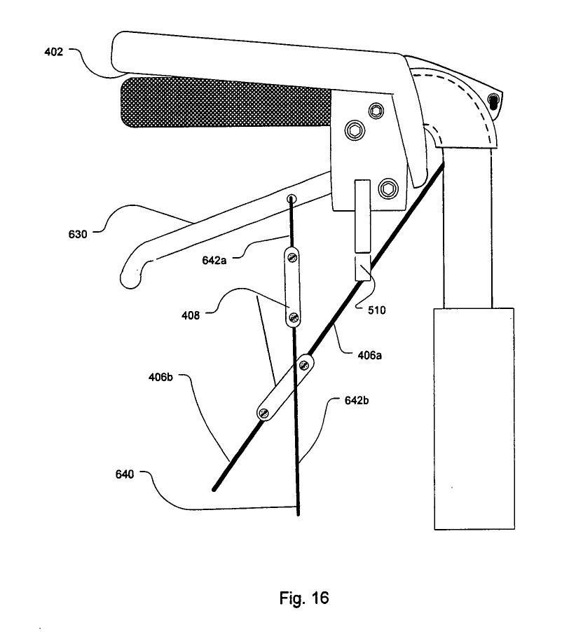

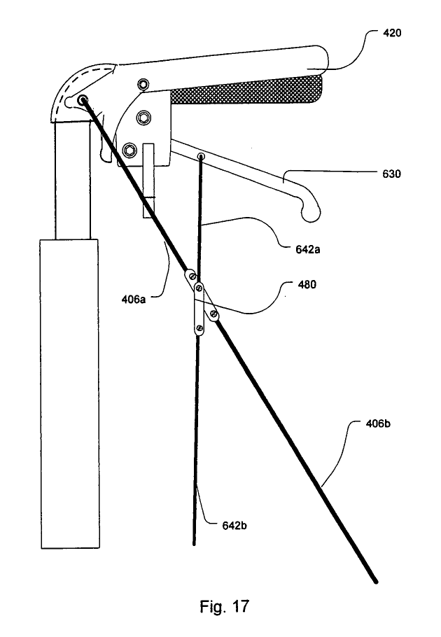

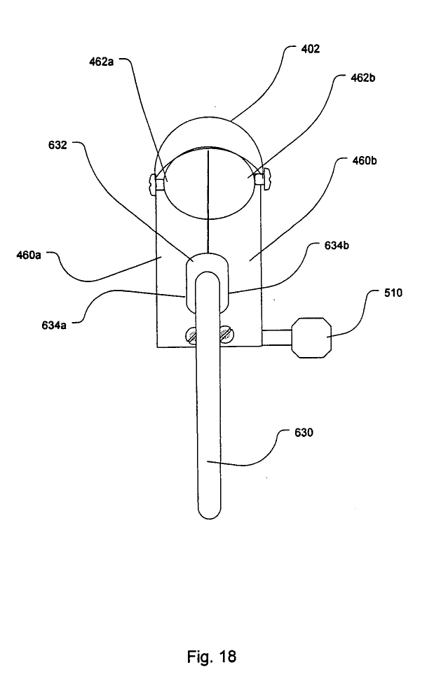

As illustrated in FIGS. 11-18 and particularly FIGS. 16 and 17, an attendant operated friction brake actuation lever 630 is pivotally coupled to the coupling members 460a and 460b to actuate the control lever 610. The brake actuation lever 630 is positioned generally below the handle of the wheelchair 102 and oriented generally parallel to the handle of the wheelchair 102. As shown in FIG. 18, the brake actuation lever 630 is pivotally disposed in an aperture 632 defined by grooves 634a and 634b extending into inner surfaces of the coupling members 460a and 460b.

Referring to FIGS. 16 and 17, a linkage 640 is coupled to and extends between the brake actuation lever 630 and either the plate portion 612 or the anchor portion 614 of the control lever 610. A length adjuster 408 may be disposed between a pair of linkage portions 642a and 642b to adjust an overall length of the linkage 640. The adjustment of the linkage 640 is identical to the adjustment of the linkage 403 described in detail above.

In operation, as the wheelchair 102 accelerates down the incline, the attendant can squeeze the friction brake actuation lever 630 toward the handle of the wheelchair 102, and concurrently the linkage 640 pivots the control lever 610 causing the plate portion 612 to engage the drive wheel 110a and/or 110b. By releasing the brake actuation lever 630, the plate portion 612 pivots away from and disengages the drive wheel 110a and/or 110b.

In one embodiment, some or all of the components of the present invention are made from materials capable of withstanding the temperatures or harsh chemicals associated with autoclaving or sterilization. The materials capable of being autoclaved or sterilized include, but are not limited to, stainless steel, aluminum, composite polymers, and other materials known to one skilled in the art.

Details of the present invention may be modified in numerous ways without departing from the spirit or scope of the present invention. For example, adjustable turnbuckles that adjust spring tension for different weight users could be replaced with a metal strap with a series of holes for different weight settings. Also, the hand release handles could utilize a clamp mounting mechanism to mount the handle on the back of the chair so that there would be no holes to drill to mount the brake system to the wheelchair. Various components of the present invention may be altered in shape or size without affecting the functionality of the device. Those skilled in the art will recognize other modifications or alternatives of the present invention without departing from the spirit or scope thereof.

Although the present invention has been described with reference to particular embodiments, one skilled in the art will recognize that changes may be made in form and detail without departing from the spirit and scope of the invention. Therefore, the illustrated embodiments should be considered in all respects as illustrative and not restrictive.

1. An automatic wheelchair brake device adapted to be installed on an existing collapsible wheelchair, the device comprising:
a brake mechanism adapted to be operably installed on only one side of a frame of the collapsible wheelchair such that a side-to-side collapsibility of the frame of the collapsible wheelchair is significantly unimpeded by the brake mechanism, the brake mechanism automatically movable between an engaged position that generally inhibits rolling movement of the wheelchair and a disengaged position permitting free rolling movement of the wheelchair in response to movement of structure on the one side of the frame of the collapsible wheel chair between a first position when the wheelchair is occupied and a second position when the wheelchair is unoccupied.

2. The automatic wheelchair brake device of claim 1, wherein the brake mechanism is adapted to re-use existing fastening points on the existing collapsible wheelchair.

3. The automatic wheelchair brake device of claim 1, wherein the brake mechanism includes a seat engagement assembly on the one side of the frame of the collapsible wheel chair between the first position when the wheelchair is occupied and the second position when the wheelchair is unoccupied, and the seat engagement assembly configured to be generally free from creation of pressure points on a patient when the wheelchair is occupied.

4. The automatic wheelchair brake device of claim 1, further comprising a second brake mechanism adapted to be operably installed on only a second side of a frame of the collapsible wheelchair such that a side-to-side collapsibility of the frame of the collapsible wheelchair is significantly unimpeded by the second brake mechanism, the second brake mechanism automatically movable between an engaged position that generally inhibits rolling movement of the wheelchair and a disengaged position permitting free rolling movement of the wheelchair in response to movement of structure on the one side of the frame of the collapsible wheel chair between a first position when the wheelchair is occupied and a second position when the wheelchair is unoccupied.

5. The automatic wheelchair brake device of claim 5, wherein each brake mechanism includes separate respective seat engagement assemblies such that each brake mechanism operates independently of the other.

6. The automatic wheelchair brake device of claim 1, wherein the brake mechanism comprises:
at least one support structure pivotally coupled to a foldable frame of the existing wheelchair;
at least one braking lever traverse to the support structure and configured to engage a drive wheel of the wheelchair when the support structure is in the engaged position; and
a biasing member coupled to and extending between a portion of the wheelchair and the support structure to bias the support structure toward the engaged position.

7. The automatic wheelchair brake device of claim 6, wherein the biasing member comprises a coiled spring.

8. An automatic wheelchair brake device for a wheelchair, the brake device comprising:
means for engaging a wheel of a wheelchair such that the wheel is substantially restrained from rotation;
means for moving said wheel engaging means between an engaged position when the wheelchair is unoccupied and a disengaged position when the wheelchair when occupied; said moving means configured to retain the wheelchairs foldability.

9. The automatic wheelchair brake device of claim 8, wherein the means for moving is further configured to be free from pressure points on an occupant of the wheelchair.

10. The automatic wheelchair brake device of claim 8, wherein the means for moving further comprises means for engaging a seat of the wheelchair.

11. An automatic wheelchair brake device comprising:
a brake mechanism movable between an engaged position that generally inhibits movement of a wheel of a wheelchair when unoccupied and a disengaged position permitting free movement of the existing wheelchair when occupied; and
a seat engagement assembly operable coupled to the brake mechanism, the seat engagement assembly configured to be generally free from creation of pressure points on an occupant of the wheelchair.

12. The automatic wheelchair brake device of claim 11, wherein the brake mechanism is configured to reuse existing fastening points on the existing wheelchair.

13. The automatic wheelchair brake device of claim 1, wherein the seat engagement assembly contacts a portion of the frame of the wheelchair.

14. The automatic wheelchair brake device of claim 11, wherein the seat engagement assembly includes means for adjusting the contact with the portion of the frame to suit a range of occupant weights.

15. The automatic wheelchair brake device of claim 11, further comprising two brake mechanisms, each operably coupled with its own separate seat engagement assembly.

16. The automatic wheelchair brake device of claim 11, wherein the brake mechanism comprises:
at least one support structure pivotally coupled to a foldable frame of the existing wheelchair;
at least one braking lever traverse to the support structure and configured to engage a drive wheel of the existing wheelchair when the support structure is in the engaged position; and
a biasing member coupled to and extending between a portion of the existing wheelchair and the support structure to bias the support structure toward the engaged position.

17. The automatic wheelchair brake device of claim 16, wherein the biasing member comprises a coiled spring.

18. An automatic wheelchair brake device for a wheelchair, the brake device comprising:
means for engaging a wheel of a wheelchair such that the wheel is substantially restrained from rotation;
means for determining the presence of an occupant in the wheelchair and moving said wheel engaging means between an engaged position when the wheelchair is unoccupied and a disengaged position when the wheelchair when occupied.

19. The automatic wheelchair brake device of claim 18, wherein the means for determining is further configured to be generally free from generating pressure points on an occupant of the wheelchair.

20. The automatic wheelchair brake device of claim 18, wherein the means for engaging and means for determining are each configured to substantially unimpede foldability of the wheelchair.

21. A method of automatically applying brakes on a wheelchair without imparing the foldability of the wheelchair or presenting pressure points on an occupant of the wheelchair, the method comprising:
providing a brake mechanism to a frame of a wheelchair;
biasing the brake mechanism in an unoccupied position when the wheelchair is unoccupied, wherein a wheel of the wheelchair is generally restrained from rotating when the chair is unoccupied; and
contacting a frame of the wheelchair proximate a seat of the wheelchair when a patient sits in the wheelchair, thereby moving the brake mechanism to an occupied position, wherein the wheel generally unrestrained from rotating.

22. The method of claim 21, wherein the step of providing includes fastening the brake mechanism to the wheelchair using existing holes in the wheelchair.

23. The method of claim 22 further comprising providing a second brake mechanism to the wheelchair.
